(19) United States
(12) Patent Application Publication
(10) Pub. No.: US 2009/0020101 A1
(43) Pub. Date: Jan. 22, 2009

(54) Device for Injecting Fuel

(76) Inventors: Andreas Posselt, Muehlacker (DE); Susanne Friedle, Bretzfeld (DE); Andreas Gutscher, Markgroeningen (DE)

Correspondence Address: KENYON & KENYON LLP, ONE BROADWAY, NEW YORK, NY, 10004, US

(21) Appl. No.: 11/884,188

(22) PCT Filed: Feb. 21, 2006
(86) PCT No.: PCT/EP2006/060134

§ 371 Date: Apr. 24, 2008

(30) Foreign Application Priority Data
Mar. 16, 2005 (DE) 102005012068.7
Jan. 25, 2006 (DE) 102006003484.8

(51) Int. Cl. F02M 59/36

(52) U.S. Cl. 123/458; 123/476

(57) ABSTRACT

A fuel injector of a fuel injecting device that is known is provided with an intensifier piston, which intensifies the pressure of the liquid supplied to the fuel injector from a rail pressure to a higher pressure by hydraulic transmission. The disadvantage is that this type of pressure intensification is very expensive and complicated. In the device according to the present invention, the pressure intensification is simpler and more economical. The present invention provides for at least one electromagnetic pressure intensifier to be provided on at least one fuel injector.

### BACKGROUND INFORMATION

A device for injecting fuel having at least one fuel injector is described in German Patent Application No. DE 100 50 599. This fuel injector is provided with an intensifier piston, which intensifies the pressure of the liquid supplied to the fuel injector from a rail pressure to a higher pressure by hydraulic transmission. The disadvantage is that this type of pressure intensification is very expensive and complicated.

It is also known to connect two feed pumps one behind the other in series in order to attain a predetermined pressure in a fuel line and in the fuel injector that is flow-connected to the fuel line. Since the pressure increase produced by the second feed pump is not needed in every operating state, this solution is very expensive.

### SUMMARY OF THE INVENTION

The device according to the present invention for injecting fuel has the advantage over the related art that the pressure intensification in the fuel injector is simpler and more economical in that an electromagnetic pressure intensifier is situated on at least one fuel injector.

It is particularly advantageous that the electromagnetic pressure intensifier is connected immediately upstream from the at least one fuel injector. In this way only a very small volume needs to be brought to a higher pressure, so that little energy is expended to increase the pressure and the pressure increase is attainable in a very short time.

According to a preferred exemplary embodiment, the electromagnetic pressure intensifier is plugged, clipped, welded, or pressed onto an input channel of the fuel injector. These connections are particularly simple and inexpensive. The electromagnetic pressure intensifier is flow-connected to a fuel line.

It is also advantageous to use an electromagnetic, piezoelectric, or magnetostrictive fuel injector as the fuel injector.

In addition, it is advantageous if the electromagnetic pressure intensifier has an electromagnet with an exciter coil and an armature, the armature being operatively connected to a piston which is positioned so that it is axially movable in a pressure chamber of the electromagnetic pressure intensifier, since a pressure intensifier of this sort is of particularly simple construction and may be produced very cost-effectively.

Additionally advantageous is that the electromagnetic pressure intensifier has an inlet channel that opens into the pressure chamber through an intake port, and that the pressure chamber has an outlet that is flow-connected to an inlet channel of the fuel injector.

It is also advantageous if the flow connection from the inlet channel to the pressure channel is closable and a pressure increase in the pressure chamber and downstream from the outlet of the pressure chamber is achievable via an axial stroke of the piston.

A preferred embodiment provides for the flow connection from the inlet channel to the pressure chamber to be closed via a separate valve in the inlet channel, via the piston, or via an interaction of the piston with the armature, followed by attainment of a brief pressure intensification via a stroke of the piston.

### BRIEF DESCRIPTION OF THE DRAWINGS

FIG. 1 shows a view of a fuel injector having an electromagnetic pressure intensifier.

FIG. 2 shows a first exemplary embodiment.

FIG. 3 shows a second exemplary embodiment of the electromagnetic pressure intensifier.

### DETAILED DESCRIPTION

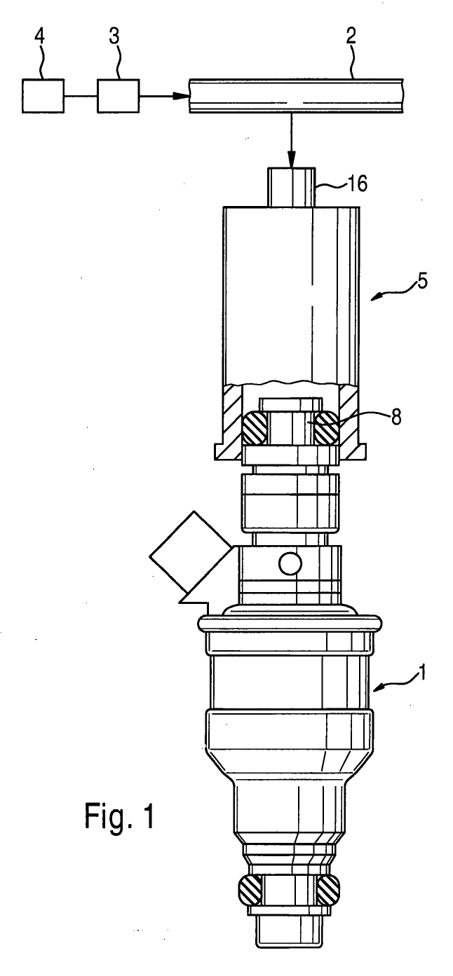

FIG. 1 shows a fuel injector having an electromagnetic pressure intensifier.

The device according to the present invention has at least one fuel injector 1, which in the case of direct injection, for example, injects fuel into a combustion chamber of a combustion engine, and in the case of manifold injection injects fuel into a so-called intake manifold of a combustion engine. The at least one fuel injector 1 is flow-connected to a fuel line 2, for example a fuel rail, through which the at least one fuel injector 1 is supplied with fuel. Fuel injector 1 is designed for example as an electromagnetic, piezoelectric, or magnetostrictive valve, but may explicitly be executed in any way desired.

A feed unit 3 is provided which is designed for example as a dynamic pump and conveys fuel from a reservoir 4 under elevated pressure into fuel line 2.

In order to fulfill the increasingly stringent emission standards, the emissions of an internal combustion engine in a so-called cold start must be reduced. This is accomplished in the related art by increasing the pressure in fuel line 2, so that the spray produced by fuel injector 1 has a smaller mean droplet size. The requisite pressure increase in fuel line 2 is so high, however, that it cannot be attained by provided feed unit 3. In the related art an additional second feed unit is therefore connected downstream from feed unit 3; it is designed, for example, as a dynamic pump, and increases the pressure in the fuel line to the necessary level, or a higher-performance, more expensive feed unit is utilized.

To eliminate the costs of this second, more expensive, feed unit, the present invention provides for an electromagnetic pressure intensifier 5 to be situated on the at least one fuel injector 1 to increase the pressure. For example, at least one pressure intensifier 5 is provided on each fuel injector 1.

The at least one electromagnetic pressure intensifier 5 is connected directly upstream from the at least one fuel injector 1, and for example is plugged, clipped, pressed, or welded or the like onto an input channel 8 of fuel injector 1. In this way, electromagnetic pressure intensifier 5 is firmly connected to fuel injector 1 and situated directly on the latter.

According to the present invention, the pressure of the fuel is not increased already in fuel line 2, as in the related art, but just shortly before and/or in fuel injector 1, via electromagnetic pressure intensifier 5. The volume within fuel injector 1 is a great deal smaller than the volume of fuel line 2 from reservoir 4 to fuel injector 1, so that significantly less energy is required to increase the pressure. In addition, the pressure increase is attained faster in injector 1 through the electromagnetic pressure intensifier 5 than through a feed unit 3 situated in fuel line 2, at a greater distance from fuel injector 1 in terms of the flow connection.

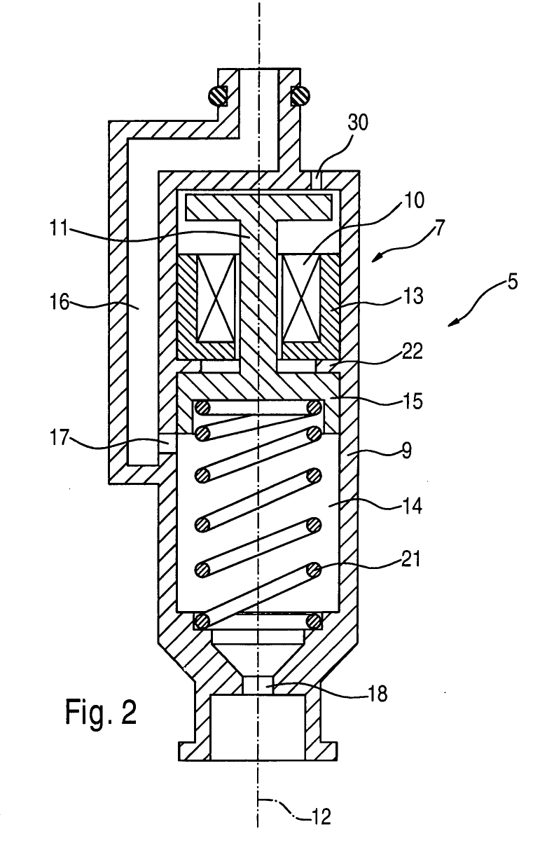

FIG. 2 shows a first exemplary embodiment of the electromagnetic pressure intensifier.

In the case of the electromagnetic pressure intensifier according to FIG. 2, the parts that remain the same or work the same as in the device according to FIG. 1 are identified by the same reference numerals.

For example, electromagnetic pressure intensifier 5 is a re-engineered electromagnetic fuel injector which is executed, for example, as described below. Electromagnetic pressure intensifier 5 has a housing 9 in which an electromagnet 7 having an exciter coil 10 and an axially movable armature 11 is situated. A pressure chamber 14, in which a piston 15 actuated by electromagnet 7 is situated so that it is axially movable with respect to an axis 12, is provided in housing 9. Armature 11, piston 15, and/or exciter coil 10 are situated, for example, centered with respect to axis 12. Over part of its axial length, armature 11 is surrounded ring-like by exciter coil 10, which is situated in an induction cup 13. An inlet channel 16 opens via an intake port 17 into pressure chamber 14 of pressure intensifier 5, for example on the periphery of pressure chamber 14. Inlet channel 16 is flow-connected upstream to fuel line 2. Pressure chamber 14 of electromagnetic pressure intensifier 5 is flow-connected to fuel injector 1 via an outlet 18.

Piston 15 of electromagnetic pressure intensifier 5 is mechanically coupled with armature 11 and connected to it. Piston 15 is moved by means of a return spring 21 into a first position, in which piston 15 bears against a stop 22 for example, and in which intake port 17 opens into pressure chamber 14. When no current is flowing through exciter coil 10, piston 15 is in this first position, thus enabling a dry-running operation.

If current is applied to exciter coil 10, armature 11 executes an axial stroke with piston 15, for example in the direction of fuel injector 1. According to the first exemplary embodiment, after a first partial stroke, piston 15 covers intake port 17, thereby closing the flow connection with inlet channel 16. Intake port 17 may also be closed in any other way desired, for example, by a separate valve in inlet channel 16. After intake port 17 is closed, the remaining partial stroke of piston 15 produces a pressure increase in pressure chamber 14 and in the part of fuel injector 1 that is flow-connected to outlet 18 of electromagnetic pressure intensifier 5, since fuel injector 1 is closed at this time and piston 15 is therefore operating on a closed volume of liquid. In this way, pressure intensifier 5 produces a pressure increase in the fuel shortly before the opening of fuel injector 1. When fuel injector 1 opens after a predefined pressure increase has been reached, at least part of the fuel whose pressure has been increased by electromagnetic pressure intensifier 5 is injected into the combustion chamber or into the intake manifold of the internal combustion engine. The predefined pressure increase is dependent on the particular operating state of the internal combustion engine, and is calculated in each case from parameters of the engine controller in order to open the fuel injector at an optimal point in time.

For example, housing 9 has an air flow hole 30 in the area of coil 10 in order to ensure pressure equalization.

After or shortly before or simultaneous with the closing of fuel injector 1, exciter coil 10 is de-energized, so that piston 15 of electromagnetic pressure intensifier 5 is moved by the force effect of return spring 21 on piston 15 from a second position back to the first position. Since intake port 17 is again open in the first position, liquid flows from inlet channel 16 into pressure chamber 14 and into fuel injector 1 downstream from outlet 18 of electromagnetic pressure intensifier 5, replacing the quantity of fuel injected in the last injection.

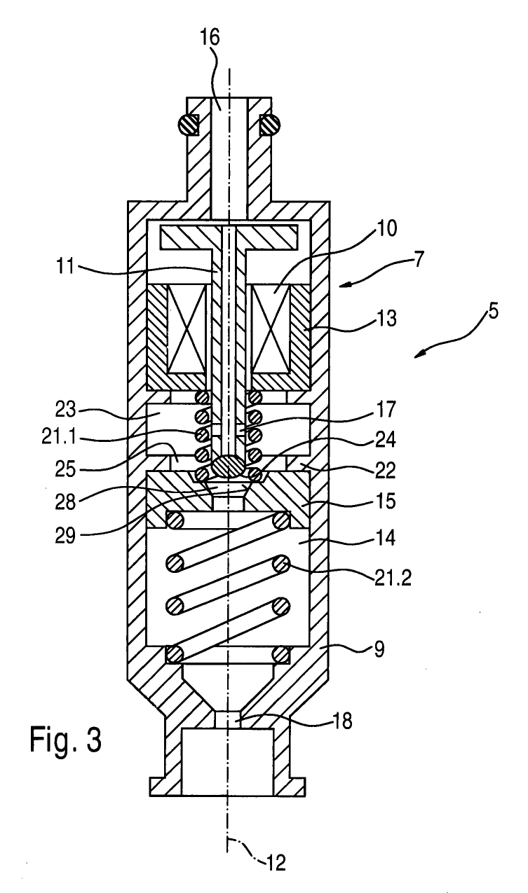

FIG. 3 shows a second exemplary embodiment of the electromagnetic pressure intensifier.

In the case of the electromagnetic pressure intensifier according to FIG. 3, the parts that remain the same or work the same as in the device according to FIG. 1 and in the electromagnetic pressure intensifier according to FIG. 2 are identified by the same reference numerals.

The second exemplary embodiment of the electromagnetic pressure intensifier differs from the first exemplary embodiment in that inlet channel 16 is closed not by piston 15, but by an interaction of armature 11 with piston 15, and that an antechamber 23 is provided between coil 10 and pressure chamber 14 when viewed in the axial direction. Inlet channel 16 does not open into pressure chamber 14, as in the first exemplary embodiment, but rather into antechamber 23. Armature 11 and piston 15 are not connected to each other in a single piece in the second exemplary embodiment, but are executed as separate parts which are situated in such a way that they are at least partially movable relative to each other in the axial direction.

In antechamber 23 a first return spring 21.1 is provided, which has one of its ends braced against piston 15 and acts on armature 11 with its other end to return it to its position. A second return spring 21.2, which has one of its ends braced against housing 9 and acts on piston 15 with its other end to return it to its position, is provided in pressure chamber 14. First return spring 21.1 is softer than second return spring 21.2.

For example, inlet channel 16 is partially formed in armature 11, and leads centrally with regard to axis 12 into antechamber 23 via at least one intake port 17 provided on armature 11. Intake port 17 may also be provided on the periphery of antechamber 23, however, and inlet channel 16 may not be provided in armature 11, but separately or on housing 9.

Armature 11, piston 15, and/or coil 10 are situated, for example, centered with respect to axis 12. Armature 11 has a closing section 24 on its end facing piston 15, which is spherically shaped, for example. Antechamber 23 is connected to pressure chamber 14 via a connecting orifice 25. Piston 15 has a pressure chamber inlet 28, which is situated centered with regard to axis 12 and has on its end facing antechamber 23a, for example, spherical valve seat 29. Valve seat 29 of piston 15 cooperates with closing section 24 of armature 11 after a predefined axial stroke of armature 11, and opens or closes the flow connection between antechamber 23 and pressure chamber 14.

When no current is flowing through exciter coil 10, piston 15 is in the first position against stop 22, with armature 11 and piston 15 spaced at a distance from each other axially. As a result, when no current is flowing through exciter coil 10 there is a flow connection from antechamber 23 via connecting orifice 25 and pressure chamber inlet 28 of piston 15 into pressure chamber 14, which is used to fill pressure chamber 14 and fuel injector 1.

If current is applied to exciter coil 10, only armature 11 first executes an axial stroke, for example in the direction of fuel injector 1. After a first partial stroke of armature 11, armature 11 strikes valve seat 29 of piston 15 with its closing section 24, and in this way closes pressure chamber inlet 28. After a first partial stroke of armature 11, armature 11 moves piston 15 along with it, so that armature 11 and piston 15 carry out a mutual stroke in the subsequent partial stroke of armature 11. After pressure chamber inlet 28 is closed, the mutual partial stroke of armature 11 and piston 15 produces a pressure increase in pressure chamber 14 and in the part of fuel injector 1 that is flow-connected to outlet 18 of electromagnetic pressure intensifier 5, since fuel injector 1 is closed at this time and piston 15 is therefore operating on a closed volume of liquid. When fuel injector 1 opens after a predefined pressure increase has been reached, at least part of the fuel whose pressure has been increased by electromagnetic pressure intensifier 5 is injected into the combustion chamber or into the intake manifold of the internal combustion engine.

After or shortly before or simultaneous with the closing of fuel injector 1, exciter coil 10 is de-energized, so that piston 15 and armature 11 execute a mutual return stroke in the direction of stop 22 due to the force effect from second return spring 21.2. After piston 15 has reached stop 22, armature 11 alone executes an additional return stroke due to the force effect from first return spring 21.1. Due to this motion of armature 11 relative to piston 15, pressure chamber 28 is again opened, so that liquid flows from inlet channel 16 and/or antechamber 23 into pressure chamber 14 and into fuel injector 1 downstream from outlet 18 of electromagnetic pressure intensifier 5, and in so doing replaces the quantity of fuel injected in the last injection.

1-10. (canceled)

11. A device for injecting fuel, comprising:
at least one fuel injector; and
at least one electromagnetic pressure intensifier situated on the at least one fuel injector.

12. The device according to claim 11, wherein the at least one electromagnetic pressure intensifier is connected directly upstream from the at least one fuel injector.

13. The device according to claim 11, wherein the electromagnetic pressure intensifier is one of plugged, clipped, welded, and pressed onto an input channel of the fuel injector.

14. The device according to claim 11, wherein the electromagnetic pressure intensifier is flow-connected to a fuel line.

15. The device according to claim 11, wherein the fuel injector is one of an electromagnetic, piezoelectric, and magnetostrictive fuel injector.

16. The device according to claim 11, wherein the electromagnetic pressure intensifier has an electromagnet with an exciter coil and an armature, the armature being operatively connected to a piston which is situated so that it is axially movable in a pressure chamber of the electromagnetic pressure intensifier.

17. The device according to claim 16, wherein the electromagnetic pressure intensifier has an inlet channel which opens into the pressure chamber via an intake port.

18. The device according to claim 17, wherein the pressure chamber has an outlet which is flow-connected to an inlet channel of the fuel injector.

19. The device according to claim 18, wherein the flow connection from the inlet channel into the pressure channel is closable and a pressure increase in the pressure chamber and downstream from an outlet of the pressure chamber is achievable via an axial stroke of the piston.

20. The device according to claim 19, wherein the flow connection from the inlet channel into the pressure chamber is closable via one of (a) a separate valve in the inlet channel, (b) the piston, and (c) an interaction of the piston with the armature.
